(19) United States
(12) Patent Application Publication
(10) Pub. No.: US 2004/0191485 A1
(43) Pub. Date: Sep. 30, 2004

(54) Plastic body having low thermal conductivity, high light transmission and a capacity for absorption in the near-infrared region

(76) Inventors: Herbert Groothues, Weiterstadt (DE); Volker Mende, Darmstadt (DE); Hans Lorenz, Darmstadt (DE); Wolfgang Scharnke, Darmstadt (DE); Guenther Ittmann, Gross-Umstadt (DE); Thomas Hasskerl, Kronberg (DE); Norbert Brand, Darmstadt (DE); Bernhard Schaefer, Gross-Gerau (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/485,257

(22) PCT Filed: Jul. 17, 2003
(86) PCT No.: PCT/EP02/07932

(30) Foreign Application Priority Data
Aug. 9, 2001 (DE) 101 38 134.4
Aug. 28, 2001 (DE) 101 41 314.9

(51) Int. Cl. B32B 3/00

(52) U.S. Cl. 428/166; 428/188

(57) ABSTRACT

A plastic body including a base molded body produced from a transparent, thermoplastic base material, and that includes at least two opposing flat layers interconnected by vertical or diagonal connecting elements. One of the flat layers is provided with an additional layer of a plastic matrix in a transparent, plastic base material. The additional layer is an IR-absorbent layer containing at least one IR-absorber that does not impair transparency of the plastic body and has an average transmission of less than 80% in the region of the near-infrared radiation (780 nm to 1100 nm). The plastic body has a light transmission of between 15% and 86%, a maximum heat transition coefficient of 4 W/m2K and a minimum Sk value of 1.15. The plastic body can be used, e.g., as a glazing element, a roofing element, a heat insulating element.

The invention relates to a plastics article with low thermal conductivity, high light transmittance, and absorption in the near infrared region on one side of the article, and to its use as a thermally insulating and sun-screening material for roofing and for glazing.

### PRIOR ART

The patent specification EP 0 548 822 B1 describes an article which transmits light and reflects IR and comprises an amorphous base material composed of plastic which transmits light and of IR-reflecting particles whose orientation is parallel to the surface and which have been arranged within a covering layer of thickness from 5 to 40 μm, composed of a transparent binder and adhering to the base material, and which has a selectivity coefficient to DIN 67507 greater than 1.15.

These plastics articles with coextruded layers which comprise IR-reflecting pearl luster pigments are commercially available by way of example in the form of quadruple-web sandwich panels composed of polymethyl methacrylate. Similarly coated polycarbonate panels are also known in the form of double-web sandwich panels or two-layer lattice sandwich panels.

Transparent, IR-absorbent articles composed of plastics are described in:

EP 927741: thermoplastics which comprise a copper dithiocarbamate compound and can be injection-molded.

JP 10157023: thermoplastics which comprise IR-absorbent dithiol metal complexes.

EP 607031, JP 06240146: thermoplastics which comprise

IR-absorbent phthalocyanine metal complexes

JP 61008113: IR-absorbent adhesive films which can be applied to glazing

JP 56129243, EP 19097: plastics sheets composed of methyl methacrylate, which comprise organic copper phosphate complexes as IR absorber.

WO 01/18101 describes molding compositions, comprising IR-absorbent dyes. The molding compositions are suitable, inter alia, for the production of hollow panels, double-web sandwich panels, or multi-web sandwich panels, which optionally may also have one or more coextruded layer [sic]. In this type of design, the entire molding comprises the IR-absorbing pigment. This has the disadvantage that the heat absorbed raises the temperature of the entire plastics article, and is dissipated non-specifically in all directions.

### Object and Manner of Achieving this Object

It is an object of the present invention to provide a plastics article which can be produced easily and which can be used as a glazing element and/or roofing element and/or as an insulating element, and which has better capability than the prior art to eliminate heating due to insolation. The preferred intention is to provide a clear, transparent plastics article.

The object is achieved by way of a

plastics article composed of a base molding which has been manufactured from a transparent thermoplastic base material, and which is composed of at least two opposite sheet-like layers (1a, 1b), which have been bonded to one another by way of vertical or diagonally arranged fillets (2), where one of the sheet-like layers (1a) has been provided with an additional layer (3) composed of a plastics matrix of transparent plastics base material, characterized in that the additional layer (3) is an IR-absorbent layer which comprises one IR absorber not impairing the transparency of the plastics article and having an average transmittance of less than 80% in the near infrared radiation region (from 780 nm to 1 100 nm), and the light transmittance (D65) of the plastics article is from 15 to 86%, its heat transfer coefficient is 4 W/m²K or smaller, and its SC is 1.15 or greater.

When comparison is made with the known IR-reflecting plastics articles, the known IR-reflecting pigments of pearl luster type are replaced by IR-absorbent compounds. Since the latter may be regarded as soluble in the plastics matrix, they do not per se impair the transparency of the plastics article. A transparent plastics article is obtained instead of a translucent plastics article. A problem which arises when the IR absorber is used, unlike when use is made of the IR-reflecting pigments, which reflect the heat outward, is that the heat is absorbed into the plastics matrix. In principle, a risk exists that the plastic will overheat when exposed to insolation. Surprisingly, however, this effect can be compensated by using the IR absorber in combination with a plastics article which is composed of two or more sheet-like layers arranged in parallel (1a, 1b, where appropriate 1c, 1d, etc.), which have been bonded to one another by vertically or diagonally arranged fillets (2). The heat arising in the IR-absorbent layer is primarily dissipated upward, because of convection. As a result, only a small amount of heat can reach the cavities within the panels, e.g. the cavities in a double-web sandwich panel. The result is a plastics article which combines, simultaneously, a heat transfer coefficient of 4 W/m²K or smaller with an SC of at least 1.15. This synergistic effect of IR absorber and air-filled cavities situated thereunder becomes several times more powerful in multilayered panels, e.g. with from two to five layers or webs, i.e. multi-web sandwich panels, in particular triple-web sandwich panels or quadruple-web sandwich panels, or multilayer lattice sandwich panels because the lower air layers develop an additional thermal insulation.

If the number of layers exceeds an optimum, the synergistic effect in turn reduces. In that case, the light transmittance T reduces to a greater extent than the total energy transmittance g, thus undesirably reducing the selectivity coefficient T/g. This disadvantageous effect occurs in the case of panels having six or more layers.

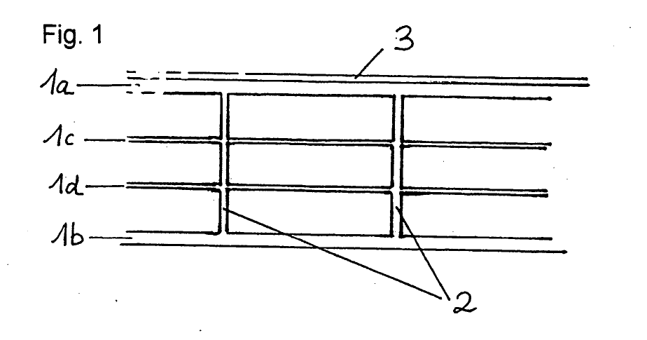

FIG. 1 illustrates the invention by way of example, but this representation does not restrict the invention.

FIG. 1: Diagrammatic cross section of a quadruple-web sandwich panel with (1a) upper web, (1b) lower web, intermediate webs (1c) and (1d), fillets (2) and outer layer (3) which comprises the IR absorber.

### DESCRIPTION OF THE INVENTION

The invention provides a plastics article, composed of a base molding which has been manufactured from a transparent thermoplastic base material, and which is composed of at least two opposite sheet-like layers (1a, 1b), which have been bonded to one another by way of vertical or diagonally arranged fillets (2), where one of the sheet-like layers (1a) has been provided with an additional layer (3) composed of a plastics matrix of transparent plastics base material, characterized in that the additional layer (3) is an IR-absorbent layer which comprises one or more IR absorber(s) not impairing the transparency of the plastics article and having an average transmittance of less than 80%, preferably less than 65%, in the near infrared radiation region (from 780 nm to 1 100 nm), and the light transmittance (D65, DIN 67 507) of the plastics article is from 15 to 86, preferably from 25 to 70, in particular from 35 to 65%, its heat transfer coefficient is (to DIN 52612) 4 or smaller, preferably from ? [sic] to 3 W/m2K [sic], and its SC (SC, T/g to DIN 67507) is 1.15 or greater, preferably from 1.2 to 1.8, in particular from 1.3 to 1.6.

### The Base Molding

The base molding is composed of at least two opposite sheet-like layers (1a, 1b), which have been bonded to one another by vertical or diagonally arranged fillets (2). The sheet-like layers are preferably parallel to one another. In the case of a double-web sandwich panel, for example, two opposite and parallel web layers, namely the upper web (1a) and lower web (1b) are present with corresponding fillets (2). A triple-web sandwich panel also has an intermediate web (1c) arranged parallel to the upper and lower web. In the case of a lattice sandwich panel, the fillets may, at least to some extent, have a diagonal arrangement.

The base molding may therefore be a double-web sandwich panel, in particular a multi-web sandwich panel, preferably a triple-web sandwich panel, or particularly preferably a quadruple-web sandwich panel or a lattice sandwich panel.

### Usual Dimensions are

Thickness of plates in the range from 10 to 60 mm. Width from 300 to 3 000 mm. Thickness of upper and lower web: from about 1 to 3 mm Thickness of intermediate web and fillets: from about 0.3 to 2 mm. Lengths: up to about 6 000 mm or more (appropriately cut to length as required)

### Materials

The base molding is substantially composed of a transparent thermoplastic base material which a [sic], for example, can be a polymethyl methacrylate plastic, an impact-modified polymethyl methacrylate (see, for example, EP-A-0 733 754), a polycarbonate plastic (branched or linear polycarbonate), a polystyrene plastic, styrene-acrylic-nitrile [sic] plastic, a polyethylene terephthalate plastic, a glycol-modified polyethylene terephthalate plastic, a polyvinyl chloride plastic, a transparent polyolefin plastic (e.g. capable of production via metallocene-catalyzed polymerization), or an acrylonitrile-butadiene-stryrene [sic] (ABS) plastic. It may also also [sic] withstand [sic] mixtures (blends) of various thermoplastics.

By way of example, a transparent thermoplastic base material has a light transmittance (D65) of from 15 to 92, preferably from 65 to 90%.

In certain applications, e.g. if the intention is to avoid dazzling due to very intense insolation, it is also possible for a scattering agent, e.g. BaSO₄, to be added, for example in amounts of from 0.5 to 5% by weight, to the transparent thermoplastic base material, or for another light-scattering agent, e.g. light-scattering beads, to be added, the result being that the initially transparent plastic becomes light-scattering and translucent. By way of example, light-scattering beads may be added in concentrations of from 0.1 to 30% by weight, preferably from 0.5 to 10% by weight. Crosslinked light-scattering beads composed of copolymers of methyl methacrylate and styrene or benzyl methacrylate are, for example, known, for example from DE 35 28 165 C2, EP 570 782 B1, or EP 656 548 A2, these being particularly suitable for base moldings composed of polymethyl methacrylate.

### The IR-absorbent Layer

The outer layer of the plastics article (1a), termed upper web in the case of a sandwich panel, preferably has, on its outer side, an additional layer (3) composed of plastic, this layer being an IR-absorbent layer which comprises one or more IR absorbers. The additional layer (3) may be a coextruded layer or may be a lacquer layer or may be a film layer applied by lamination.

The thickness of the additional layer (3) is, by way of example, in the range from 2 to 250 μm. The thicknesses of coextruded layers (3) are preferably in the range from 5 to 250, preferably from 20 to 150, in particular from 50 to 125 μm. The thicknesses of laminated layers (3) are preferably in the range from 10 to 250, preferably from 10 to 100 μm. The thicknesses of lacquered layers (3) are preferably in the range from 2 to 50, preferably from 5 to 25 μm, after drying.

It is also possible, though less preferred, for there to be no irreversible bond between the additional layer (3) and the base molding. The additional layer (3) may take the form of a separate sheet or film in the extrusion or casting process and be assembled in a composite with base molding, e.g. with the aid of a frame, or be bonded with the aid of an adhesion promoter. The layer thicknesses may then, by way of example, be from 10 to 250, preferably from 10 to 100 μm for superposed films or from 250 μm to 5 mm, preferably from 1 to 4 mm, for sheets.

The IR-absorbent layer (3) may also comprise a UV absorber at usual concentrations, e.g. from 0.1 to 15% by weight, in order to protect the IR absorber and the plastics matrix from degradation by UV radiation. The UV absorber may be a volatile, low-molecular-weight UV absorber, or a low-volatility, high-molecular-weight UV absorber, or a copolymerizable UV absorber (see, by way of example, EP 0.359 622 B1).

The plastics matrix of the IR-absorbent layer (3) is composed of transparent plastics base material which may be thermoplastic or thermoelastic, or may have been crosslinked. The type of transparent, thermoplastic base material of which the plastics base material of the IR-absorbent layer (3) is composed is preferably the same type of transparent, thermoplastic base material of which the base molding is also composed, i.e., by way of example, a polymethyl methacrylate plastic, an impact-modified polymethyl methacrylate plastic, a polycarbonate plastic (branched or linear polycarbonate), a polystyrene plastic, a polyethylene terephthalate plastic, or an acrylonitrile-butadiene-stryrene [sic] (ABS) plastic.

The base molding here may, by way of example, be composed of a relatively highly relatively viscous [sic] variant of a type of plastic, e.g. polymethyl methacrylate and the plastics matrix here may be composed of a relatively low-viscosity variant of the same type, e.g. of a relatively low-viscosity polymethyl methacrylate which, by way of example, is particularly well suited to coextrusion.

Due to the presence of the IR absorber, the outer layer (3) appears greenish to bluish turquoise, depending on the IR absorber used, as therefore does the entire plastics article. In instances where the desire is to eliminate or attenuate this perceived color, a light-scattering pigment, e.g. a white pigment, e.g. barium sulfate, may be added in amounts of from 0.5 to 5% by weight. This has the technical advantage that the dazzle effect is mitigated when the material transmits sunlight, because the light is scattered. Where appropriate, compensation for the perceived color may be achieved by adding dyes.

In certain applications, e.g. if the intention is to avoid dazzling due to very intense insolation, it is also possible for a scattering agent, e.g. BaSO₄, to be added to the transparent plastics base material of the additional layer (3), or for another light-scattering agent, e.g. light-scattering beads, to be added, the result being that the initially transparent plastic becomes light-scattering and translucent.

Where appropriate, there may also be one or more other, by way of example coextruded, lacquered, or laminated layer [sic] composed of plastic, preferably of transparent plastic, on the additional layer (3) composed of transparent plastic, which is one IR-absorbent layer. In this instance, the IR-absorbent layer is not outside but within the outer layer of the plastics article. The other layer(s) may have various functions, e.g. mechanical support of the IR-absorbent layer, e.g. as a scratch-resistant coating, anti-graffity [sic] coating, UV-absorber layer, pigment-containing layer for bringing about the perceived color, etc. [sic] the thicknesses of the other layers are preferably in the range from 2 to 200, preferably from 5 to 60 μm.

By way of example, it can be advisable in the case of a sandwich panel composed of polycarbonate, also to apply to the IR-absorber layer an additional, for example coextruded, layer which comprises a UV absorber and protects the polycarbonate from premature damage by weathering (sandwich panels composed of polycarbonate with an additional UV absorber layer are known from EP 0 359 622 B1, by way of example). The UV absorber may be a volatile, low-molecular-weight UV absorber, or a low-volatility, high-molecular-weight UV absorber, or a copolymerizable UV absorber, and may be present at a concentration of, by way of example, from 2 to 15% by weight in a layer whose thickness is, by way of example, in the range from 2 to 100 μm.

### The IR Absorber

The use of the IR-absorbent compounds suitable for working of the invention as an additive to various thermoplastics is known in principle (see prior art).

The additional layer (3) comprises an IR absorber not impairing the transparency of the plastics article. This means that the plastics article remains clear and transparent in the presence of the IR absorber which it comprises. This is possible because the IR absorber may be regarded as being soluble in the plastics matrix of the additional layer, or has been copolymerized therewith. Because soluble IR absorbers are of relatively high molecular weight, there is generally no migration into plastics layers situated below or, where appropriate, above the material.

The IR absorber may be an organic Cu(II) phosphate compounds [sic]. By way of example, preference is given to an organic Cu(II) phosphate compounds [sic] which may comprise of [sic] 4 parts by weight of methacryloyloxyethyl phosphate (MOEP) and of one part by weight of copper(II) carbonate (CCB) (see example 1).

Other suitable substances are, by way of example, organic Cu(II) phosphate complexes, e.g. as described in the patents JP 56129243 and EP 19097. By way of example, these compounds may be used as comonomers within polymerizing lacquer layers composed of polymethyl methacrylate plastic. Due to their crosslinking action, they simultaneously provide increased scratch resistance of the plastics surface.

The IR absorber may be a phthalocyanine derivative. Preference is given to phthalocyanine derivatives as, for example, as [sic] described in the patents EP 607031 and JP 06240146.

The IR absorber may be a perylene derivative or, by way of example, a quaterrylenetetracarbonimide compound, e.g. as described in EP 596 292.

Preference is given to the non-crosslinking compounds, because, by way of example, these are suitable for the coextrusion process or for application in non-polymerizing lacquers which spontaneously cure after vaporization of a solvent. The application of an IR-absorbent layer by lamination using prefabricated films has the advantage the [sic] the production of the films generally allows the layer thickness distribution to be more uniform. Film layers applied by lamination and comprising the IR absorber are mostly more uniform than corresponding coextruded layers. IR absorbers with high molecular weight or copolymerizing IR absorbers have the advantage of being particularly migration-resistant, i.e. they exhibit practically no migration into the plastics layers situated below or, where appropriate, above the material on exposure to high production temperatures or high service temperatures, or as a consequence of a period of use.

The concentration of the IR absorber in a coextruded or laminated plastics matrix is from 0.01 to 5, preferably from 0.05 to 2, in particular from 0.1 to 0.5% by weight.

In polymerizing lacquer systems, by way of example, the concentration may be from 0.1 to 5% by weight, based on the dry weight of the lacquer.

In non-polymerizing lacquer systems, by way of example, the concentration may be from 0.2 to 5% by weight, based on the dry weight of the lacquer.

### Selectivity Coefficient (SC, T/g to DIN 67 507)

The ratio of light transmittance (T) to total energy transmittance (g) is intended to be greater than 1.15, preferably from 1.2 to 1.8, in particular from 1.3 to 1.6. The total energy transmittance (g) describes that proportion of the energy from insolation that passes through the article. It is composed of directly transmitted radiation and a proportion of heat arising through absorption. The manner of achieving the high level of thermal insulation is that the article is composed of at least two solid layers, respectively decoupled thermally by air-filled cavities. Thin fillets bond the layers to one another. The IR-absorbent layer is composed of a covering layer which is composed of a transparent plastic and comprises one or more IR-absorbent compounds, and adheres to the base material. By way of example, the concentration of the IR-absorbent compound and the layer thickness of the covering layer are preferably to be selected in such a way that the maximum absorption in the region between 780 and 1 100 nm is at least 25%, in particular at least 50%. The average absorption in the region between 780 and 1 100 nm may preferably, by way of example, be at least 5, particularly preferably at least 10, in particular at least 15%. The geometry of the multi-web sandwich panel is to be selected in such a way that the heat transfer coefficient to DIN 52612 is smaller than or equal to 4, preferably from 3 to 1.5 W/m²K.

### Use

The plastics article of the invention may be used as a glazing element, roofing system element, or thermal insulation element.

### Advantages of the Invention

The visible energy content of insolation is about 50%, the UV radiation content is about 5%, and NIR radiation makes up about 45%. All three types of radiation contribute to the heating of glazed spaces.

Thermal-insulation glazing of the prior art is based either on reflection or on absorption of insolation. Simple systems reduce the total energy transmittance by reducing the amount of radiation transmitted in the entire insolation region (from 300 nm to 2 500 nm). Carbon black pigments absorb the radiation in this region and thus, depending on the layer thickness and, respectively, the concentration, reduce the total energy transmittance. However, the light transmittance is likewise reduced. The selectivity coefficient, which describes the ratio of the light transmittance to the total energy transmittance, is therefore no greater in these systems than in standard glazing, and indeed is poorer if carbon black pigments are used. However, there are applications, e.g. greenhouses, in which a high selectivity coefficient is advantageous. A high selectivity coefficient is achieved through selective high transmittance in the visible wavelength region between 380 nm and 780 nm and screening-out of IR radiation (>780 nm) and also UV radiation (<380 nm). In the case of reflecting systems, this selectivity is generated via interference. The alternatives are to vapor-deposit layers of differing refractive indices on the surfaces, the layer thicknesses being in the submicrometer range, or to use pigments which intrinsically comprise interference layers of this type. Vapor-deposition on the surface is technically very complicated, and the use of the pigments leads to marked scattering of the radiation, thereby losing transparency. Absorbent systems use substances which have only low absorption in the visible region and have high absorption in the NIR region.

A disadvantage of these systems is that the absorbed radiation leads to a temperature rise in the body of the glazing. Drawing 1 illustrates the situation. The insolation composed of UV, visible and NIR radiation, is insolent on the glazing. The substantial portion of the radiation in the visible region is transmitted. That proportion of the radiation which is absorbed by the glazing is dissipated in the form of long-wave thermal radiation toward the outside (qₐ) and to a small extent toward the inside (qᵢ). Substantially more heat is dissipated toward the outside than toward the inside, this being due to the convection factors utilized by the invention.

That portion of the long-wave thermal radiation which is dissipated into the chamber toward the inside contributes to the total energy transmittance. If the absorption of the IR radiation takes place only at the outer side of the transparent article, then the lower the heat transfer coefficient (k value) of the glazing article, the smaller the proportion qᵢ. The result of this is a marked increase in the selectivity coefficient.

Another advantage is capability for easy production. The coextrusion process can directly equip low-k-value multi-web sandwich panels with an overlayer which comprises the IR absorber, in a continuous process.

Light Transmittance, Total Energy Transmittance, and Selectivity Coefficient

The light transmittance and the total energy transmittance depend on the nature, concentration, and layer thickness of the IR absorber in the overlayer, and also on the base article. The appropriate light transmittance depends on the application. In greenhouses it should be very high, because it directly affects the yield. In the case of roofing systems for pedestrian precincts or large-surface-area glazing in air-conditioned buildings, on the other hand, a very low total energy transmittance is important. Additional use of carbon black pigments or of other colorants in the overlayer, these absorbing both in the visible region and in the NIR region, can still further reduce the light transmittance and, to the same extent, the total energy transmittance. The minimum light transmittance should be 30%, and if the base articles comprise double-web sandwich panels the maximum light transmittance may by up to 86%. In the case of uncoated sandwich panels the selectivity coefficient is about 1, and the SCs determined on systems single-side-coated as in the invention were above 1.4.

By way of example, the plastics article takes the form of a multi-web sandwich panel, composed of at least two parallel plastics layers, which have been bonded to one another by vertically or diagonally arranged fillets. Typical thicknesses for the two outer sheets are from 0.2 mm to 5 mm, preferably from 0.5 mm to 3 mm. Typical thicknesses for any inner sheets present are from 0.05 to 2 mm, preferably from 0.1 mm to 1 mm. In order to achieve effective thermal insulation, the distance between the sheets should be at least 1 mm, preferably more than 4 mm. The fillet thickness should be from 0.2 mm to 5 mm, preferably from 0.5 mm to 3 mm. The appropriate fillet separation is from 5 mm to 150 mm, preferably from 10 mm to 80 mm. The design of the entirety of the article should be such that the heat transfer coefficient k to DIN 52619 is smaller than 4 W/m²K, preferably smaller than 3 W/m²K. The base material is composed of a transparent plastic, and examples of materials suitable here are a polymethyl methacrylate plastic, an impact-modified polymethyl methacrylate (see by way of example EP-A 0 733 754), a polycarbonate plastic (branched or linear polycarbonate), a polystyrene plastic, styrene-acrylic-nitrile [sic] plastic, a polyethylene terephthalate plastic, a glycol-modified polyethylene terephthalate plastic, a polyvinyl chloride plastic, a transparent polyolefin plastic (e.g. capable of production via metallocene-catalyzed polymerization), or an acrylonitrile-butadiene-stryrene [sic] (ABS) plastic. It may also be composed of mixtures (blends) of various thermoplastics. For the purposes of the invention, polymethyl methacrylate means rigid amorphous plastics made from at least 60% by weight, preferably at least 80% by weight, of methyl methacrylate. The polycarbonate plastics are predominantly aromatic polycarbonates of bisphenols, in particular of bisphenol A.

The IR-absorbent covering layer

The covering layer is composed of a transparent, adhesive binder. The adhesion is to be sufficiently high to prevent the coating from breaking away during bending of the article when it is cold or when it has been heated as a thermoplastic. The selection of the plastics used in an individual case depends on the requirements of the coating process and on the performance characteristics. From the points of view of good adhesion to a large number of plastics, high weathering resistance, high yellowing resistance, and high aging resistance, particularly well suited binders are those based on polacrylate [sic] plastics and on polymethacrylate plastics. In the case of the lacquer coating, the covering layer is produced from a liquid coating composition which comprises, alongside the binder and the IR-absorbent substance, a carrier liquid for the binder. These may be conventional lacquer solvents, such as esters, alcohols, ethers, ketones, aromatics, chlorinated hydrocarbons, or mixtures of these. In the case of reactive resins, the polyfunctional acrylic esters assume this function. The amount of the carrier liquid depends on the processing method; by way of example, it may make up from 30% to 85% of the coating material. The binder may also be present in dispersed form in the coating composition, preferably in the form of an aqueous plastics dispersion. The dispersion may—as is familiar in paint technology—have been equipped with flow control agents. These are understood to be—predominantly high-boiling—organic [sic] solvents or swelling agents for the dispersed plastic.

This IR-absorber layer comprises one or more compounds which has [sic] low absorption in the visible wavelength region between 380 nm and 780 nm, in particular in the region between 450 nm and 650 nm, and high absorption in the region 780 nm to 2 000 nm, in particular in the region between 780 nm and 1 100 nm. These IR absorbers may be admixed with the plastics material of the additional layer (3), or else copolymerized with this material. The concentration of the IR absorber in the overlayer depends on its extinction coefficient and on the thickness of the overlayer. It should be selected in such a way that the average value for transmittance of the additional layer (3) in the wavelength region between 780 nm and 1 100 nm is less than 80%, preferably less than 65%. The additional layer (3) may also comprise UV absorbers, which protect firstly the base material, and also the IR absorber, from UV radiation, and moreover also increase the selectivity coefficient, because the UV radiation energy transmittance (about 5% of the total energy in insolation) is also suppressed.

### EXAMPLES

### Example 1

The IR absorber used comprised a copper phosphate complex. This was prepared by stirring 20 g of methacryloyloxyethyl phosphate (MOEP) with 5 g of copper(II) carbonate (CCB) and 1 g of H₂O in 260 g of methyl methacrylate for 30 min at from 50° C. to 60° C. and then for 4 h at room temperature, followed by filtration. 0.05% of 2,2′-azobis(isobutyronitrile) (AIBN) was then added, and the mixture was polymerized for 17 hours at -40° C. between 2 glass sheets separated by 10 mm. The finished polymethyl methacrylate (PMMA) sheet is transparent and has a pale blue color. The light transmittance [T(D65)], total energy transmittance [g], and selectivity coefficient [T/g] to DIN 67 507 of this sheet were determined. Furthermore, from this sheet and [sic] 3 mm-thick IR-absorber-free polymethyl methacrylate composite systems were produced, the sheet separation in these being 16 mm, and the abovementioned values were likewise determined from these composite systems. These data are shown in Table 1:

TABLE 1

| | Light | | |
|---|---|---|---|
| Number of | transmittance | Total energy | Selectivity |
| sheets | (D65) | transmittance | coefficient |
| 1 | 85.1% | 65.4% | 1.3 |
| 2 | 79.1% | 56% | 1.41 |
| 3 | 73.9% | 50.7% | 1.46 |
| 4 | 69.5% | 46.7% | 1.49 |

As the number of sheets increases, the selectivity coefficient becomes greater, because the energy absorbed is increasingly dissipated toward the outside, i.e. the side facing toward the radiation source.

### Example 2

A quadruple-web sandwich panel (thickness 32 mm) composed of impact-modified polymethyl methacrylate (PMMA) was extruded with a coextrusion layer of thickness 100 μm on the upper web. The coextrusion layer composed of PMMA comprises 0.26% of the IR absorber of quaterrylene tetracarboximide compound type (Uvinul® 7790 IR). The table below lists light transmittance, total energy transmittance, and selectivity coefficient for the individual upper web, upper web and lower web, upper web, one intermediate web and lower web, upper web two intermediate webs and lower web.

| | Light | | Selectivity |
|---|---|---|---|
| Number of | transmittance | Total energy | coefficient |
| sheets | (D65) | transmittance g | T/g |
| Upper web | 78% | 67.8% | 1.15 |
| Upper web + lower web | 72% | 58.5% | 1.23 |
| Upper web + intermediate | 67% | 54% | 1.25 |
| web + lower web | | | |
| Upper web + 2 | 63% | 50% | 1.26 |
| intermediate webs + | | | |
| lower web | | | |

1-13 (Canceled).

14. A plastics article, comprising:
a base molding manufactured from a transparent thermoplastic base material, and which is composed of at least two opposite sheet-like layers bonded to one another by vertical or diagonally arranged fillets,
wherein one of the sheet-like layers is provided with an additional layer composed of a plastics matrix of transparent plastics base material, and
wherein the additional layer is an IR-absorbent layer comprising at least one IR absorber not impairing transparency of the plastics article and having an average transmittance of less than 80% in near infrared radiation region from 780 nm to 1100 nm, light transmittance of the plastics article is from 15 to 86%, its heat transfer coefficient is 4 W/m²K or less, and its SC is 1.15 or greater.

15. The plastics article as claimed in claim 14, wherein the article is a double-web sandwich panel, a multi-web sandwich panel, a triple-web sandwich panel, a quadruple-web sandwich panel, or is a lattice sandwich panel.

16. The plastics article as claimed in claim 14, wherein the base molding is substantially composed of a polymethyl methacrylate plastic, of an impact-modified polymethyl methacrylate, of a polycarbonate plastic, of a polystyrene plastic, of a styrene-acrylic-nitrile plastic, of a poly-ethylene terephthalate plastic, of a glycol-modified polyethylene terephthalate plastic, of a polyvinyl chloride plastic, of a transparent polyolefin plastic, of an acrylonitrile-butadiene-stryrene (ABS) plastic, or of a mixture of various thermoplastics.

17. The plastics article as claimed in claim 14, wherein the additional layer of the plastics article is one of a coextruded layer applied to the base molding, a lacquer layer, or a film layer applied by lamination.

18. The plastics molding as claimed in claims 14, wherein there is no irreversible bond between the additional layer and the base molding.

19. The plastics article as claimed in claim 14, wherein the additional layer is composed of one of a plastics matrix of one of a transparent plastics base material which is a thermoplastic, a thermoelastic or crosslinked plastic, or is identical with a type of plastic in the base molding.

20. The plastics article as claimed in claim 14, wherein the IR-absorbent layer also comprises a UV absorber.

21. The plastics article as claimed in claims 14, wherein at least one other layer composed of plastic is applied to the additional layer.

22. The plastics article as claimed in claim 14, wherein the IR absorber is an organic Cu(II) phosphate compound.

23. The plastics article as claimed in claim 22, wherein the organic Cu(II) phosphate compound is a methacryloyloxyethyl phosphate/copper(II) complex.

24. The plastics article as claimed in claim 14, wherein the IR absorber is a phthalocyanine derivative.

25. The plastics article as claimed in claim 14, wherein the IR absorber is a quaterrylenetetracarbonimide compound.

26. The use of a plastics article as claimed in claim 14 as a glazing element, roofing system element, or thermal insulation element.
